(19) United States
(12) Patent Application Publication
(10) Pub. No.: US 2016/0304057 A1
(43) Pub. Date: Oct. 20, 2016

(54) PRO-TEC Wiper Blades and Arms

(71) Applicant: Shenise Delain Berry, Chicago, IL (US)

(72) Inventor: Shenise Delain Berry, Chicago, IL (US)

(21) Appl. No.: 14/690,543

(22) Filed: Apr. 20, 2015

(51) Int. Cl. B60S 1/04; B65D 33/16

(52) U.S. Cl. CPC B60S 1/0491; B65D 33/165

(57) ABSTRACT

An, one size fits all, personalized apparatus used on any windshields wiper blade and arm to protect against weather elements, theft, and engine debris build up.

### FIELD

The present application relates to an easily installed apparatus used on any windshield wiper blade and arm assembly that protects, personalize, and is one size fit all.

### BACKGROUND

### Background of the Invention

Consumers spend billions of dollars a year replacing damage or stolen windshield wiper blades and its apparatus due environmental factors such as inclement weather and theft. Costly also are the repair bills due to damage caused by debris build up in the top of the engine compartment.

The added fact that our society love convenience, ease of use, and personalizing bring me to the present invention.

The present invention relates to an easily install, personalized, one size fits all, protective cover made from weather resistant materials for the wiper blades and arms of any windshield wiper blade assembly.

The apparatus becomes a custom fit for any windshield wiper blade apparatus via the drawstrings pull. The apparatus securely stores and protect the wiper blade and its arm from weather elements and via weather resistant material that can be personalized. The toggle locks used for securing the drawstring in place deters theft. The width of the apparatus help to protect the of an engines compartment by hindering debris build up.

Personalizing effects are done via various colors, brand logos, or designs embedded in the material.

### SUMMARY

I claim that although similar in nature, the difference in my claim and the others cited is the simultaneous and variations of use: The one size fits all aspect which customizes, the personalization concept, and the protection aspects via the toggle locks deterring theft, and the debris defense for the top of the engine compartment.

### SPECIFICATIONS

### BRIEF DESCRIPTION

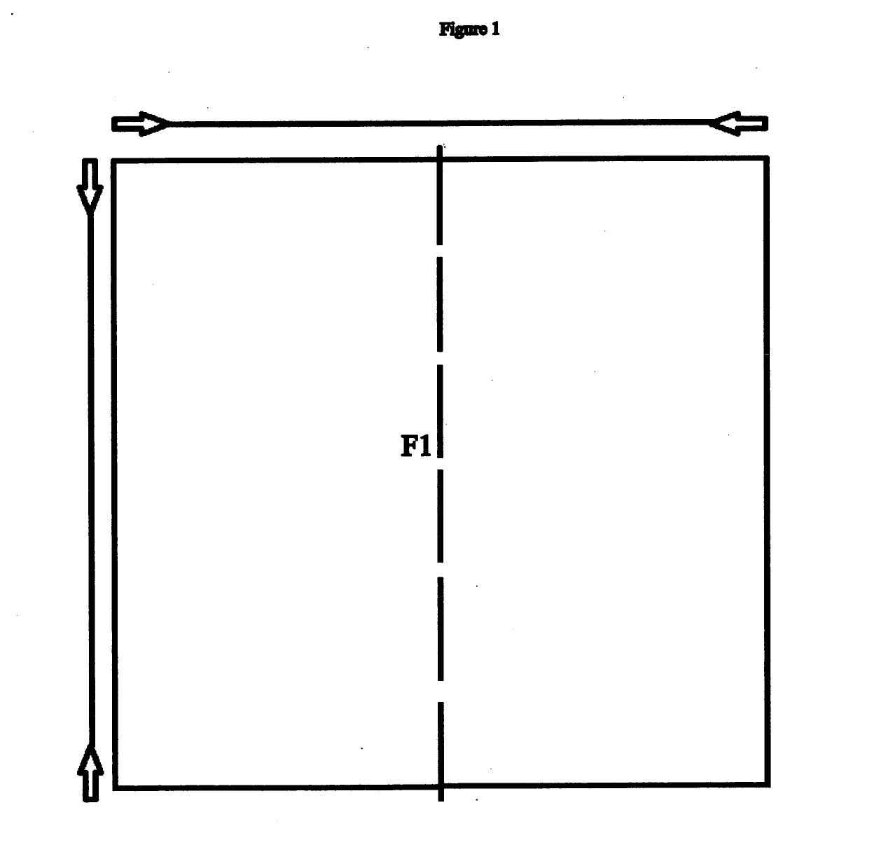

FIG. 1

Unit with fold line. (F1 fold)

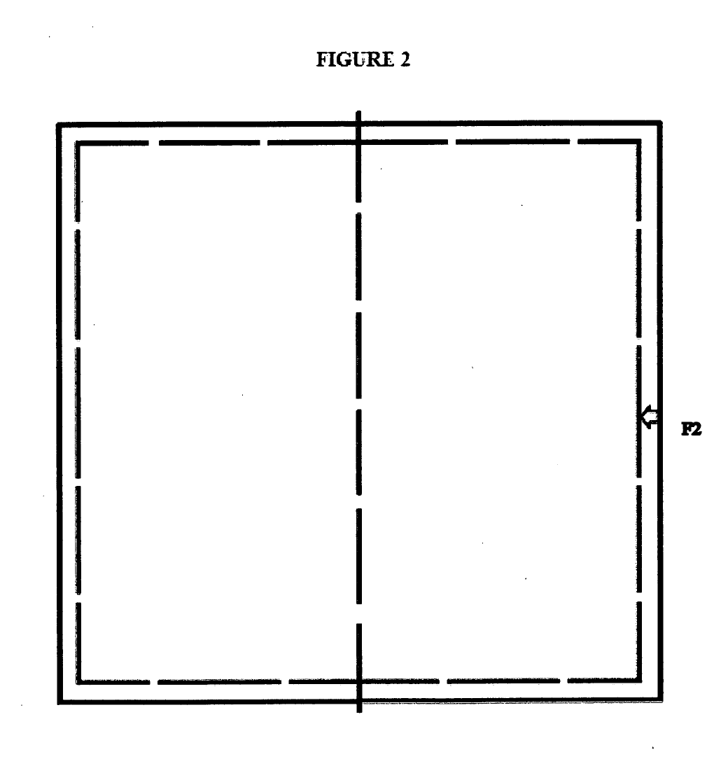

FIG. 2

Unit with perimeter folded. (F2 fold)

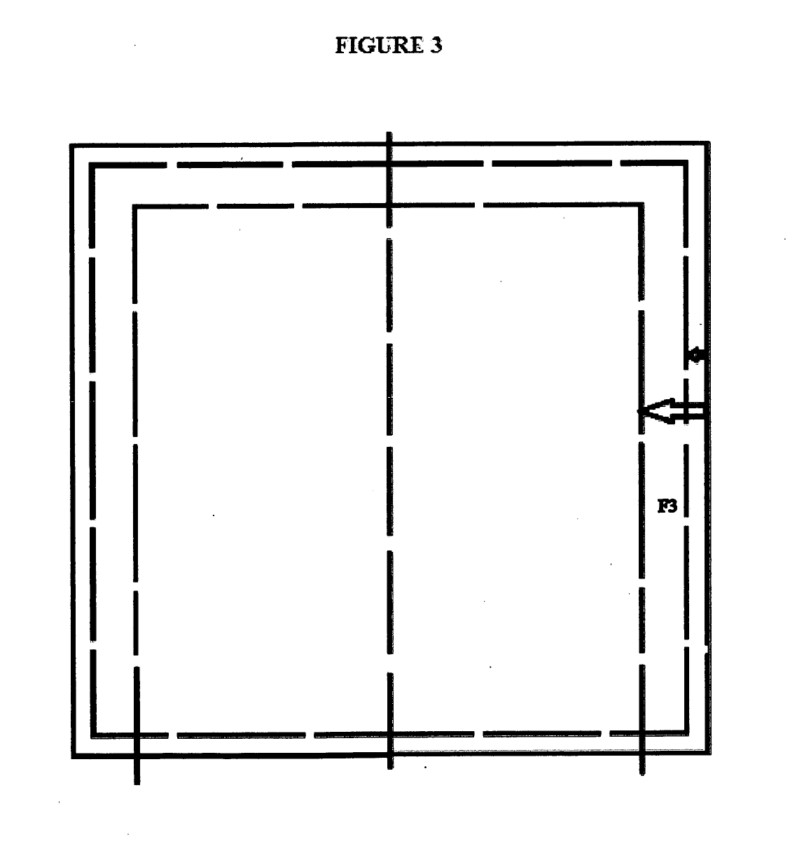

FIG. 3

Unit with an additional fold on left, right and top sides. (F3 fold)

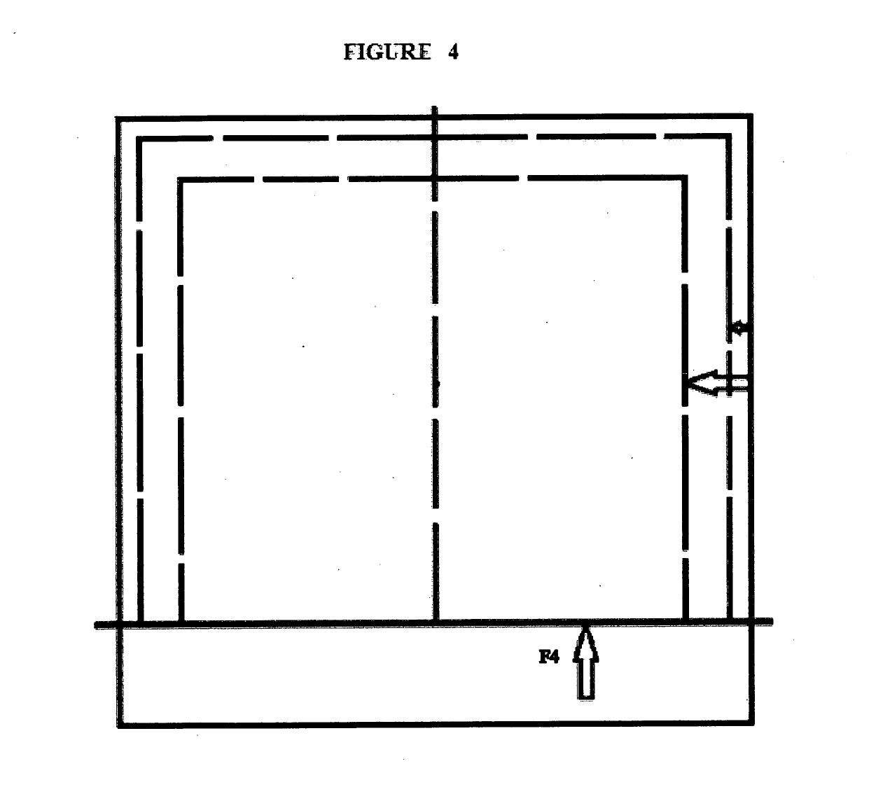

FIG. 4

Units bottom fold area for drawstring pocket. (F4 fold)

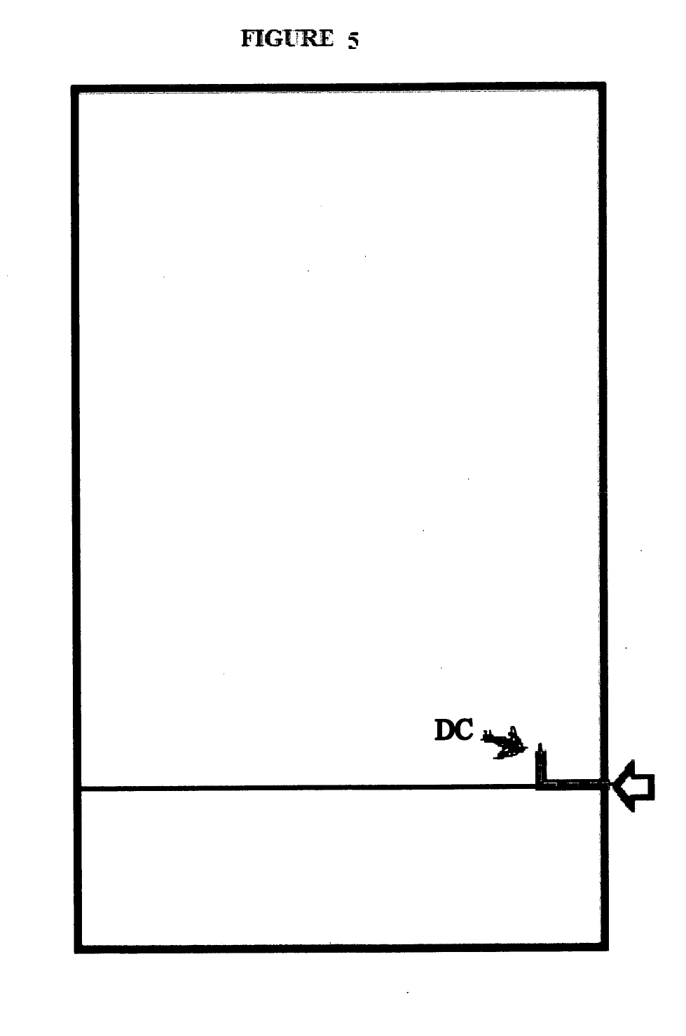

FIG. 5

Units side cut for the drawstring. (DSC)

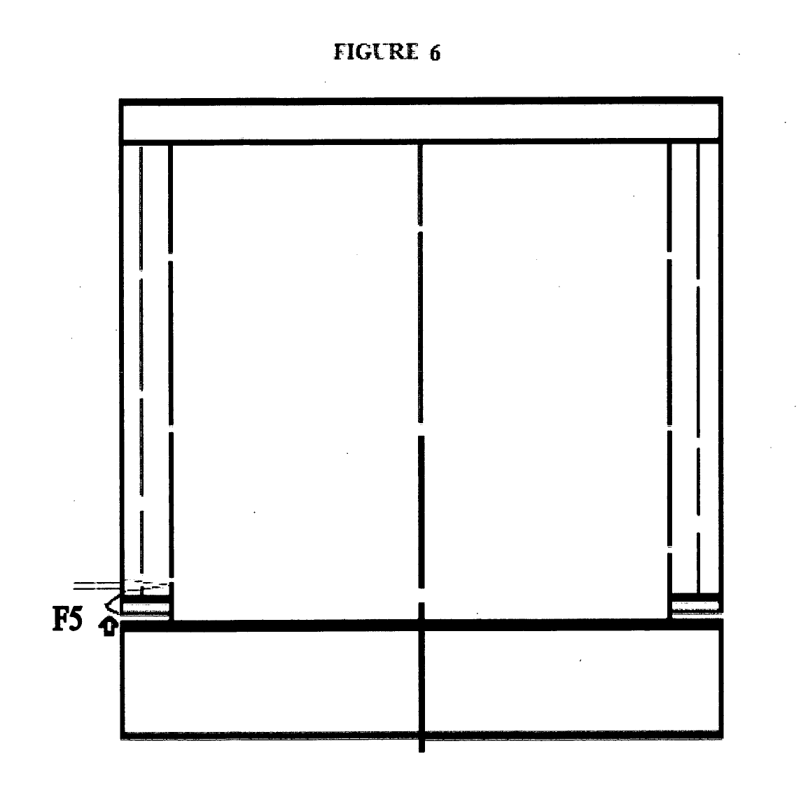

FIG. 6

Fold for hem for the side drawstring pocket. (F5 fold)

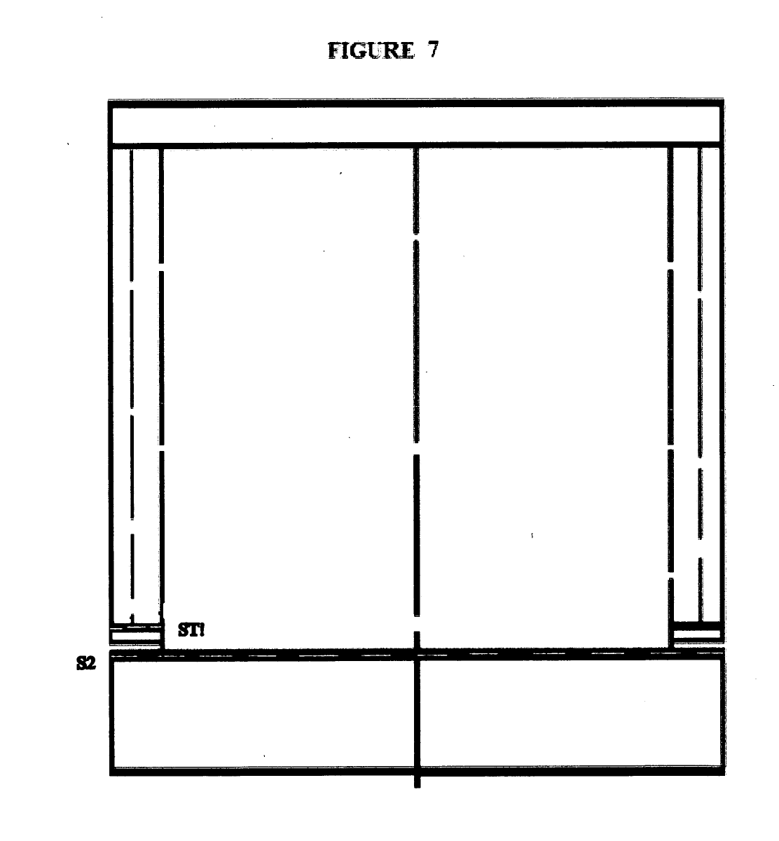

FIG. 7

Sew a stitch (St 1) in the hem of the fold F5 fold for the drawstring, and a stitch (St 2) in the top of the drawstring pocket for the drawstring. (F4 fold)

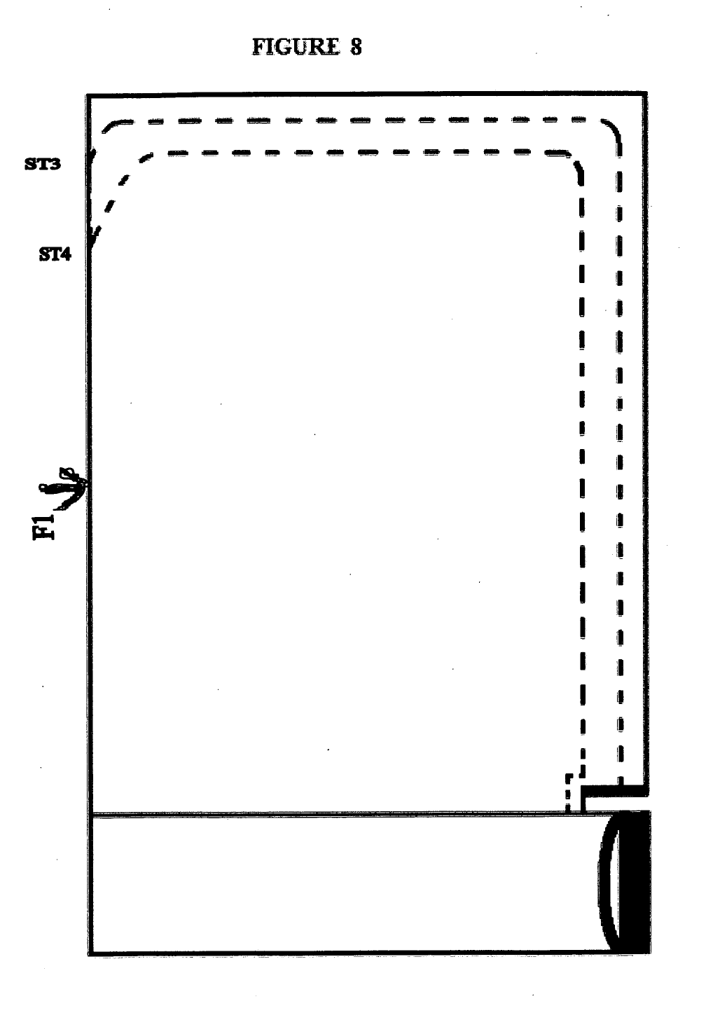

FIG. 8

Unit folded in half.

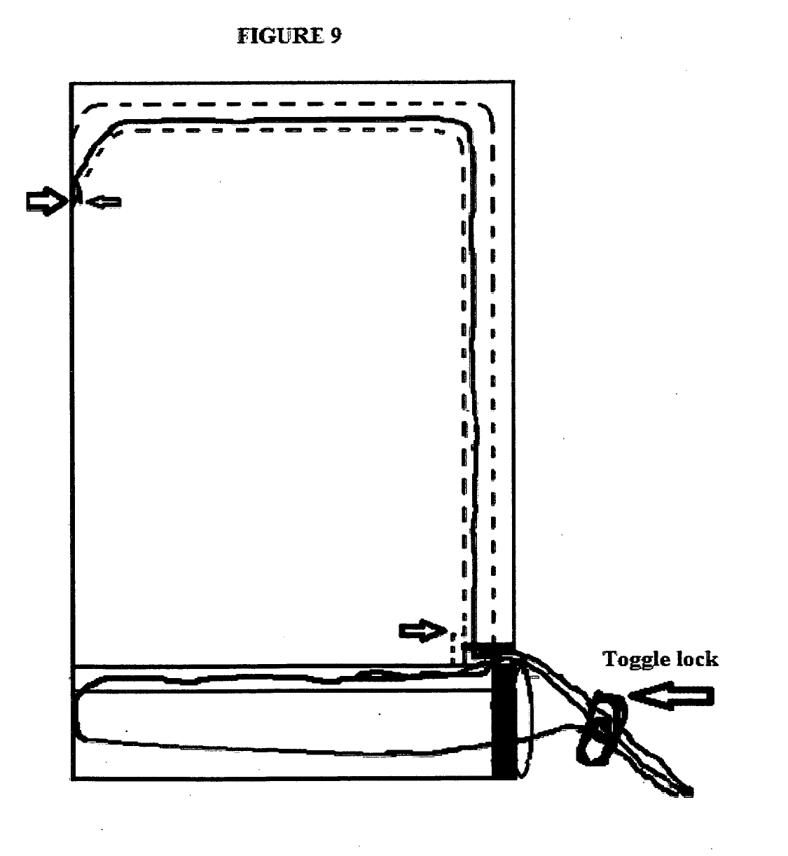

FIG. 9

Unit showing stitching and drawstring added with drawstring fished thru and pulled out from the bottom of the unit, with toggle lock added.

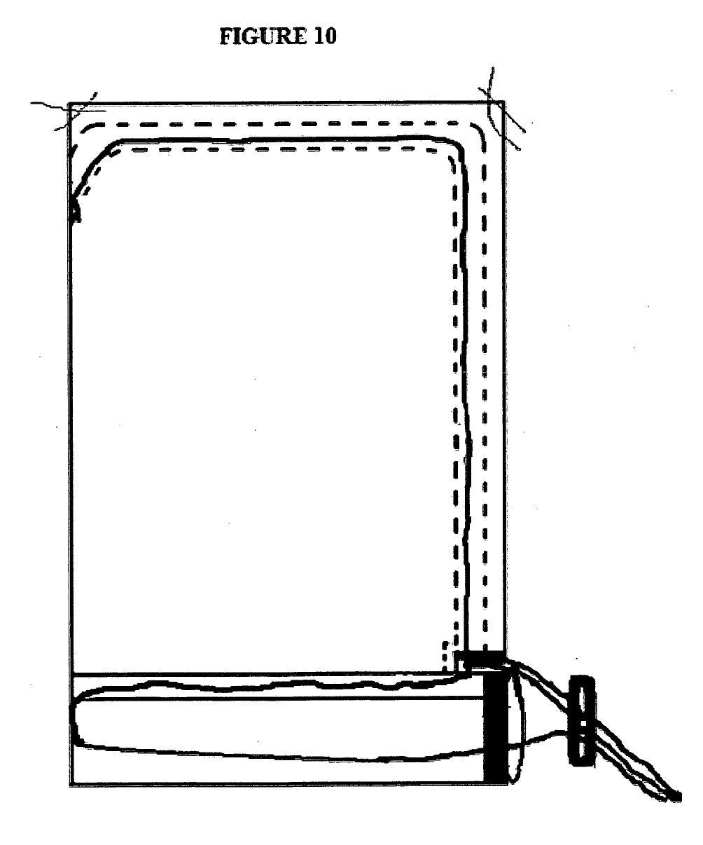

FIG. 10 Unit trimmed on both side corners with toggle lock added.

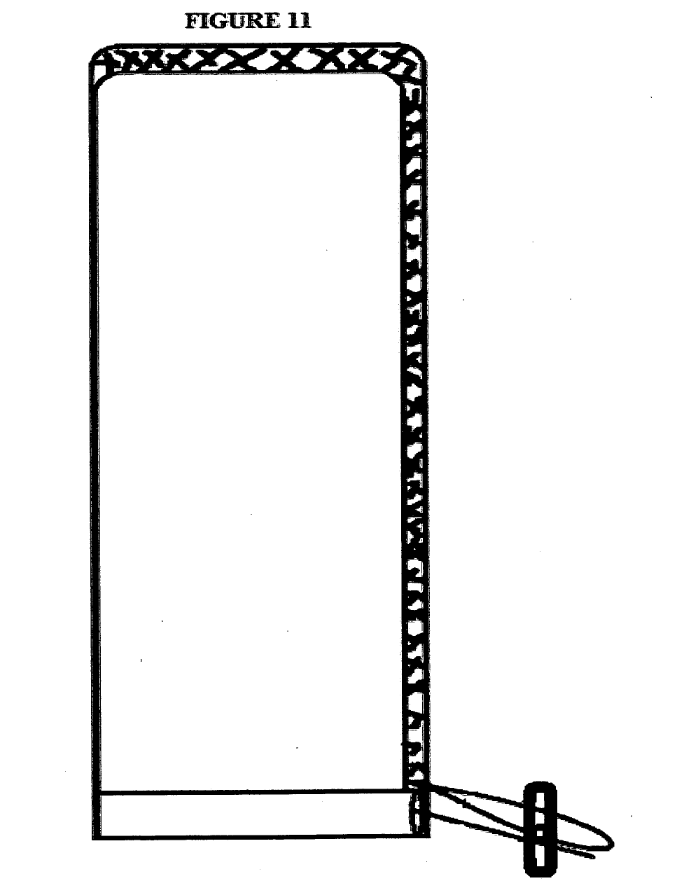

FIG. 11

Unit with the drawstring NOT pulled, turned inside out.

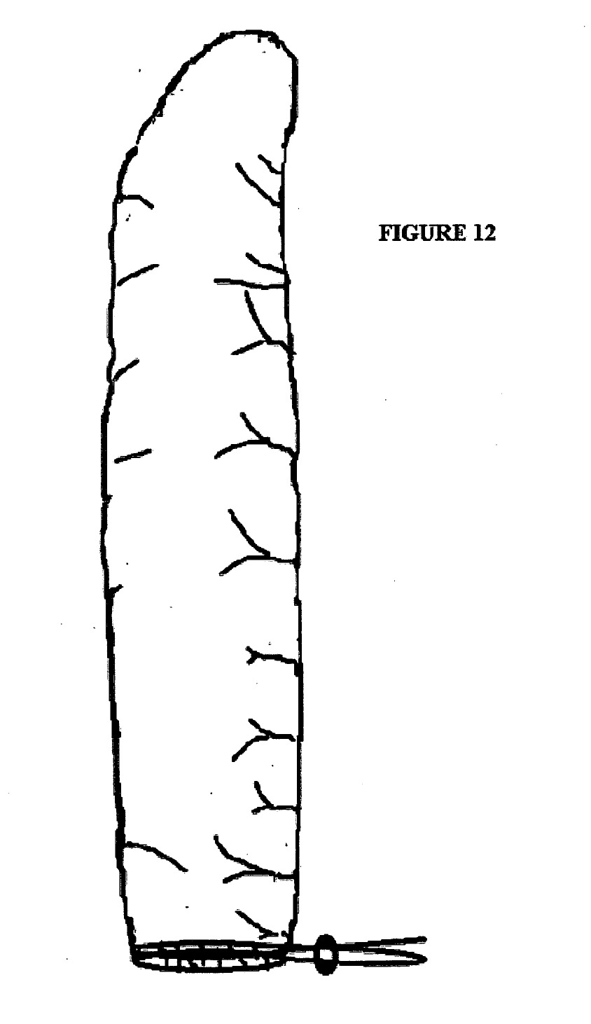

FIG. 12

Unit with drawstring pulled, turned inside out.

F is a Fold ST is a Stitch DC is a Drawstring Cut

### DETAILED DESCRIPTION

FIG. 1

Step 1). Fold in half. (Fold 1, or F1)

Step 2). Re-open

FIG. 2

Step 3). Measure and fold around perimeter. (Fold 2, or F2)

ORDER: left, right, top, bottom.

(FIG. 3)

Step 4). Measure and fold a fold three times the width of F2 on both sides and on the top. ORDER: left, right, then top.

Re-open. Open left and right side only.

FIG. 4

Step 5). Measure and fold a fold four times the width of F2 on the bottom. Order: Edge of bottom, up Fold in half, again.

(Fold 3, or F3)

FIG. 5

Step 6). On the open side (right), cut a “L” shaped cut at the top of the bottoms fold, (F4) the length and with of F2.

FIG. 6

Step 7). Unfold. Fold the units cut upwards the length of F2, or the width of the cut, on both sides.

FIG. 7

Step 8). Sew a stitch across the folded cuts on each side. (St 1)

Step 9). Sew a stitch (from left to right) across the top of the bottom fold in the middle of the F2 fold. (St 2)

Step 10). Fold in half. (be sure all sides match up evenly before the first cut, and each time it must be folded in half. (F1)

FIG. 8

Step 11). From the top left side, measuring down from the top, measure and mark the length of F2. (St 3)

Step 12). From step twelve's measurement, mark and measure a distance two times the width of F2, (St 4)

NOTE: Start the both left stitches, (ST3 and ST4) on a curve, (see FIG. 8)

Step 13). Starting on the left side at the St 4 marking, (on the fold F1) attach the drawstring by sewing a locking stitch (sew back and forth several time) to secure drawstring in place. Once the drawstring is secured then move it aside. Continue to stitch across, towards the right side, then down and around the cut done in step 7.

Step 14). Lay the drawstring back down up against the stitch (St 4).

Step 15). Starting on the left side at the St 3 marking, sew towards the right, then down and to the end at the hem. (lock stitch)

FIG. 9

Step 16). Holding onto the middle of the drawstring, fish the end of the drawstring thru the pocket at the bottom of the unit then pull thru.

Step 17). Even out the draw strings

Step 18). Attach the toggle lock to drawstring. FIG. 10

Step 19). Trim the unit as needed on the upper left and right sides.

Step 20). Turn the unit inside out

FIG. 11

Unit with the drawstring NOT pulled and toggle lock attached.

FIG. 12

Unit WITH the drawstring pulled and toggle lock attached.

I claim an one size will fit all windshield wiper blade and arm protection which can be personalized or branded and is made from weather resistant material:

1. An installed drawstring that will enable the unit to become a one size fit all apparatus via the retraction and extension of the string.

2. Three way protection via a toggle lock on the end of the drawstring which creates a deterrent for theft, the weather resistant material to that prevent weather elements from ruining the assembly, and length and width of the material which prevents debris build up in the upper engine compartment.

3. The concept of branding or personalizing each unit.
